(19) United States
(12) Patent Application Publication
(10) Pub. No.: US 2026/0285588 A1
(43) Pub. Date: Sep. 24, 2026

(54) MULTI-COMPARTMENT CONTAINER FOR STORING, DISPENSING AND COLLECTING WASTE OF A FOOD PRODUCT

(71) Applicant: Pierce Swanson, Laguna Beach, CA (US)

(72) Inventor: Pierce Swanson, Laguna Beach, CA (US)

(21) Appl. No.: 19/086,493

(22) Filed: Mar. 21, 2025

(51) Int. Cl. B65F 1/00; B65D 83/04

(52) U.S. Cl. CPC B65F 1/0053; B65D 83/0481; B65D 2209/00

(57) ABSTRACT

A food storage and waste disposal device is provided, incorporating a dual-compartment structure for controlled dispensing and mess-free waste collection. The storage section securely holds a food product and includes a selectively operable door that rotates open to release a small amount into the user's hand. A separate waste compartment with a closable lid enables the disposal of byproducts, ensuring that remnants are contained and easily managed. The interaction between the internal and external walls allows the dispensing door to be opened or closed with a simple twist, while a sloped bottom surface guides the food toward the opening. This system streamlines the consumption process for shelled snacks or wrapped candies, keeping the food fresh while preventing unwanted litter.

### CROSS REFERENCE TO RELATED APPLICATIONS

Not Applicable.

### STATEMENT RE: FEDERALLY SPONSORED RESEARCH/DEVELOPMENT

Not Applicable.

### BACKGROUND

The various aspects and embodiments described herein relate to portable storage container for sunflower seed that also includes a trash receptacle.

Many food products, such as sunflower seeds, pistachios, and wrapped candies, generate waste that must be discarded after consumption. Traditional methods of handling these foods often involve carrying a separate container for disposal or relying on makeshift waste solutions, leading to inconvenience and mess. Consumers frequently struggle with keeping food fresh while also managing waste, particularly in portable settings such as travel, outdoor activities, or office environments. Existing containers typically focus on either storage or waste collection, but few integrate both functions into a single, user-friendly design. A need exists for a compact, all-in-one device that allows users to store and dispense food in controlled portions while providing an efficient and hygienic way to collect and contain waste.

Accordingly, there is a need for an improved product.

### BRIEF SUMMARY

The product is a compact, portable container designed to store and dispense a food product while providing an integrated waste collection system. It features a main storage compartment that holds the food, a rotating mechanism that selectively opens a small dispensing door, and a separate waste compartment with a hinged lid. The rotating mechanism allows a user to dispense a controlled portion of food into their hand while keeping the rest sealed. Once the edible portion is consumed, any leftover waste, such as shells or wrappers, can be discarded into the waste compartment. The sealed lid ensures that the waste remains contained, preventing spills and odors. The design provides a convenient, mess-free way to consume foods that generate waste, making it ideal for use on the go.

More particularly, a device may be configured to store and dispense a food product while collecting waste from the food product. The device may include a storage container that may hold the food product and a door that may open and close to dispense food in small amounts. A trash container may be provided to collect waste, and a lid may open and close to receive the waste. The lid may prevent spillage when the door is closed. The door may be rotatable between open and closed positions. The storage container may include an inner wall and an outer wall, with the inner wall being rotatable inside the outer wall. The trash container may be attached to the storage container and may be removable for cleaning. The lid may include a seal to prevent odors from escaping. The storage container may have a sloped bottom surface to help food move toward the door when opened.

To use the device, a user may hold it in one hand and twist a handle to open the door. The user may tilt the device to dispense food into their hand and may then close the door to stop further dispensing. The user may open the lid of the trash container, place waste inside, and then close the lid to secure the waste.

To assemble the device, the outer wall may be attached to the body. The inner wall may be inserted into the outer wall, with a protrusion on the inner wall engaging a groove on the outer wall. A top cover may be secured to the trash container body using threads and a seal. A lid may be attached to the trash container to allow for selective opening and closing. The inner wall may be locked to the outer wall using a unidirectional bevel on the protrusion, or the protrusion may have a bidirectional bevel to allow removal of the inner wall for cleaning.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of the device, showing the storage container, trash container, door in the opened position, and lid in the closed position.

FIG. 2 is another perspective view of the device, showing the door in the closed position and the lid in the opened position, allowing waste to be inserted into the trash container through an opening.

FIG. 3 is an exploded perspective view of the device, illustrating its components, including the top cover, lid, seal, trash body, outer wall, inner wall, and other features.

FIG. 4 is a cross-sectional view of the storage container, showing the sloped bottom surface that facilitates the movement of sunflower seeds toward the door opening when the door is in the opened position.

FIG. 5 is a cross-sectional view of the inner wall and outer wall, illustrating the engagement of a protrusion with a groove, which controls the rotational movement of the door.

FIG. 5A illustrates a first embodiment of the protrusion, which includes an upper slope and a bottom flat surface, preventing the inner wall from being removed from the outer wall.

FIG. 5B illustrates a second embodiment of the protrusion, which includes both an upper slope and a bottom slope, allowing for bidirectional insertion and removal of the inner wall from the outer wall.

FIG. 6 is another view of the outer wall and inner wall, highlighting the configuration of the handle portion and the protrusion.

### DETAILED DESCRIPTION

The device 10 may be configured to store and dispense a food product while collecting waste associated with the food product. The device 10 may include a storage container 18 for initially storing the food product, a door 16 for selectively opening and closing the storage container 18, a trash container 20 for collecting waste, and a lid 22 that may be opened and closed to allow for waste disposal while preventing spillage of the food product when the door 16 is closed.

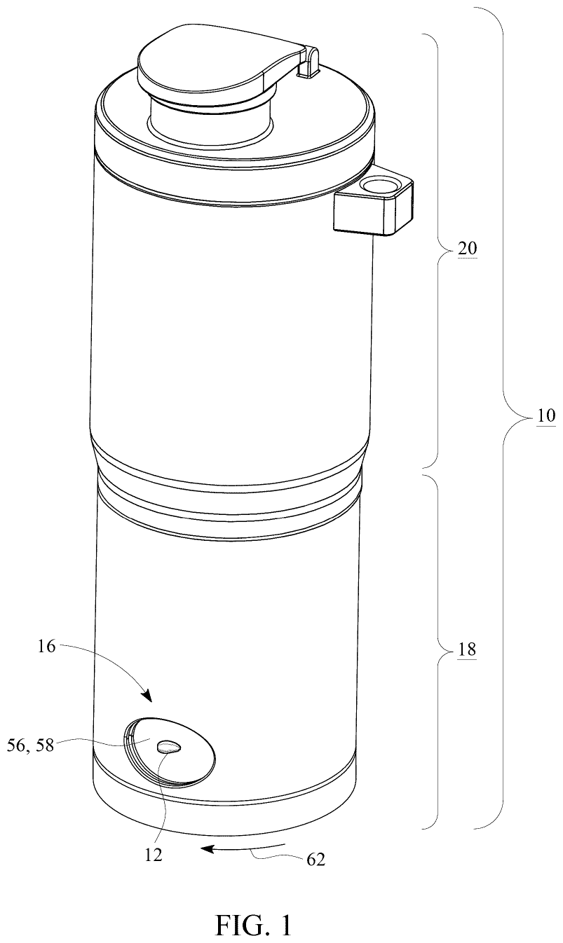

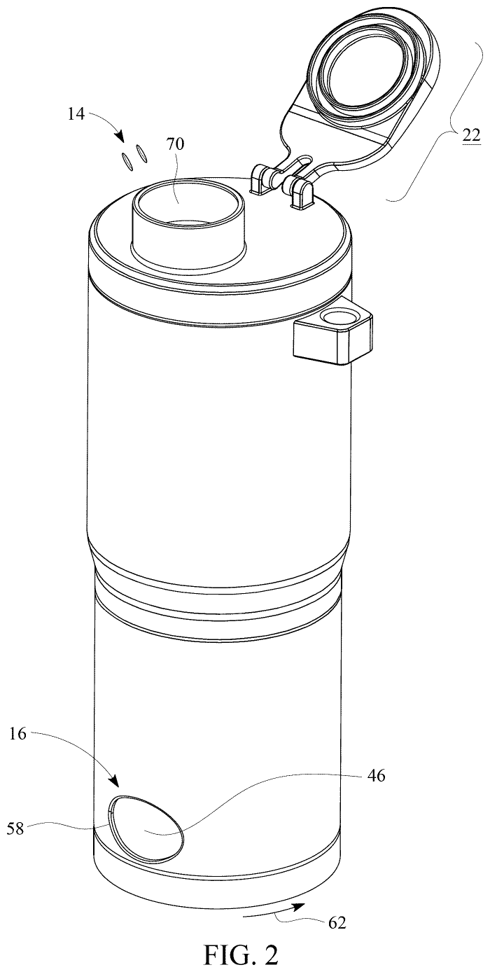

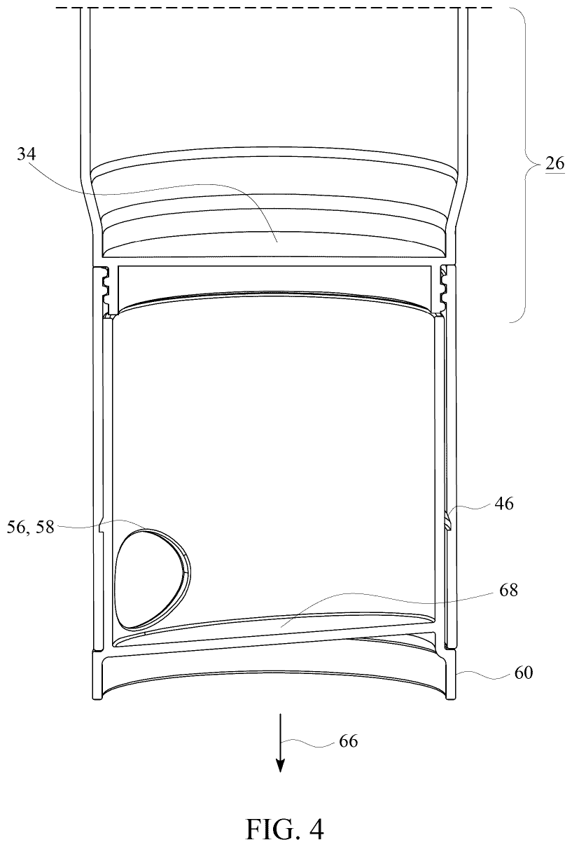

The storage container 18 may be sized to accommodate multiple handfuls of sunflower seeds 12 or other similar food products. The door 16 may be configured to traverse between an opened position (FIG. 1) and a closed position (FIG. 2). When in the opened position, the user may pour out a portion of the sunflower seeds 12 into their hand. After obtaining the seeds, the user may close the door 16 to prevent further dispensing. The door 16 may be closed by turning the bottom portion of the device, referred to as the handle portion 60 (see FIG. 4), in the direction of arrow 62 (see FIG. 1). The user may remove the kernel from the sunflower seed 12 and discard the shell 14 into the trash container 20 by opening the lid 22. The shell 14 is inserted into the opening 70 (see FIG. 2), which allows for easy disposal into the trash container 20.

The lid 22 may be traversable between an open position (FIG. 2) and a closed position (FIG. 1). When in the closed position, the lid 22 may remain shut despite tilting or movement of the device 10, preventing the unintentional spillage of waste in the trash container 20.

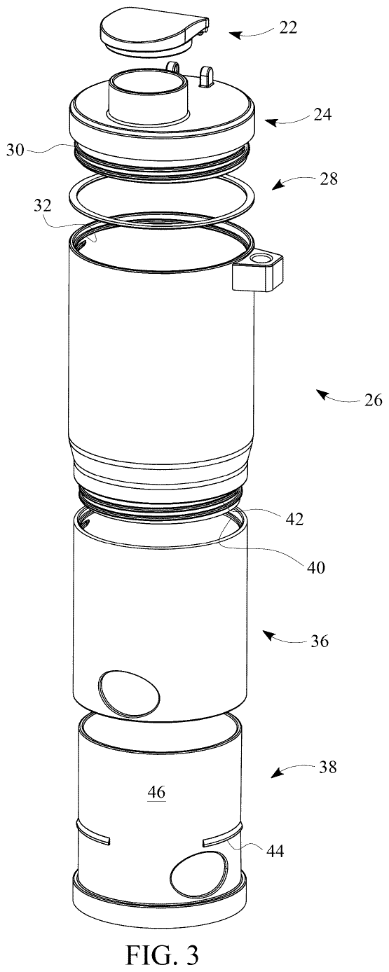

Referring now to FIG. 3, the seed container 18 may be formed of multiple components including a top cover 24, the lid 22, a trash body 26, and a seal 28. The seal 28 may be disposed over the threads 30 of the top cover 24, which engage the internal threads 32 of the trash body 26. Upon engagement, the seal 28 may form an airtight barrier between the top cover 24 and the trash body 26. The trash body 26 may define a bottom surface 34 (see FIG. 4) and, together with the top cover 24 and lid 22, may form the trash container 20 for collecting the shell 14 of the sunflower seed 12.

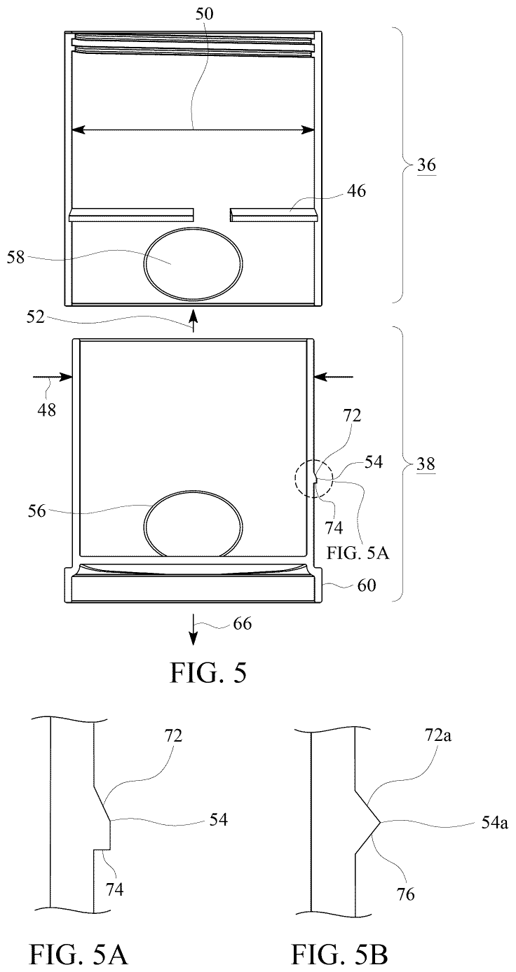

The storage container 18 may include an outer wall 36 and an inner wall 38, as shown in FIG. 5. The outer wall 36 may be threaded onto the trash body 26, as discussed above, wherein an internal thread 40 of the outer wall 36 may engage an external thread 42 of the trash body 26, as shown in FIG. 3. The inner wall 38 may be configured to be inserted into but not removed from the outer wall 36, as shown in FIGS. 5 and 5A. The exterior surface 46 of the inner wall 38 may have a ridge 54 that engages with a corresponding groove 46 on the inner surface of the outer wall 36. The outer diameter 48 of the inner wall 38 may be smaller than the inner diameter 50 of the outer wall 36, allowing the inner wall 38 to be inserted in the direction of arrow 52.

The inner wall 38 may include a circular protrusion 54. The groove 46 may include multiple grooves 46, and the protrusions 54 may include multiple protrusions 54. The positions of the grooves 46 and protrusions 54 may be aligned to allow for controlled movement of the inner wall 38. When the door 16 is in the closed position, a distal end of the protrusion 54 may butt against one end of the groove 46. When the door 16 is in the opened position, the opposite end of the protrusion 54 may engage the opposite end of the groove 46. In the opened position, the door opening 56 of the inner wall 38 may align with the door opening 58 of the outer wall 36, allowing the sunflower seeds 12 to be dispensed (FIGS. 1 and 4). The inner wall 38 may be rotated in the direction of arrow 62 to open the door 16 or in the direction of arrow 64 to close the door 16 by gripping the handle portion 60 and twisting while holding the outer wall 36 in the direction of arrow 62 (see FIG. 2).

The protrusion 54 may have a unidirectional bevel configuration so that the inner wall 38 may be inserted into the outer wall 36 but may not be removed. This configuration is shown in FIGS. 5 and 5A. In this configuration, the bevel may be positioned on the upper side of the protrusion 54 while the lower side of the protrusion 54 may be flat, as shown in FIG. 5A. Alternatively, as shown in FIG. 5B, the protrusion 54a may have a bidirectional bevel configuration, allowing the inner wall 38 to be removed from the outer wall 36 when a force is applied in the direction of arrow 66 (see FIG. 4) on the handle portion 60 while gripping the outer wall 36. The bidirectional configuration may include a bevel on both the upper and lower sides of the protrusion 54a (FIG. 5B).

The handle portion 60 may be textured to increase friction and improve grip. The texture may be a series of raised ridges, knurling, rubberized coating, or another type of surface modification that enhances user grip. The textured surface may help prevent slipping when rotating the handle portion 60 to open or close the door 16.

The bottom surface 68 of the inner wall 38 may slope downward toward the door opening 56 to urge sunflower seeds 12 to fall through the door 16 when in the opened position. The slope may be between 1 and 45 degrees, and preferably around 3 degrees.

To use the device 10, the user may close the lid 22 and twist the handle portion 60 in the direction of arrow 62 to open the door 16. The user may tilt the device 10 so that sunflower seeds 12 fall into the hand of the user. After obtaining the desired amount of sunflower seeds, the user may close the door 16 as described above. The user may remove the kernel from the seed 12 with their teeth and discard the shell 14 into the trash container 20. The shell 14 may be deposited into the trash container 20 through an opening 70 when the lid 22 is in the open position.

To empty and clean the trash container 20, the user may twist off the top cover 24 from the body 26 of the trash container 20. To clean the seed container 18, the user may pull the inner wall 38 out of the outer wall 36.

The device 10 may be used for food products other than sunflower seeds 12. For example, candy with wrappers may be stored in the seed container 18, while the wrappers may be discarded in the trash container 20. Additionally, other small food products with waste components, such as pistachios (where the shell is discarded) or gum (where the used gum and wrapper can be discarded), may be stored and dispensed in a similar manner.

FIGS. 5A and 5B illustrate two different embodiments of the protrusion 54. In FIG. 5A, the protrusion 54 includes an upper slope 72 and a bottom flat surface 74. In FIG. 5B, the protrusion 54a includes an upper slope 72a and a bottom slope 76, allowing for bidirectional removal.

FIG. 3 illustrates an exploded perspective view of the device 10, showing the individual components.

FIG. 4 provides a cross-sectional view of the seed container 18, showing the sloped bottom surface 68 that facilitates the dispensing of sunflower seeds.

FIG. 5 illustrates a cross-sectional view of the inner wall 38 and the outer wall 36, showing the engagement between the protrusion 54 and groove 46.

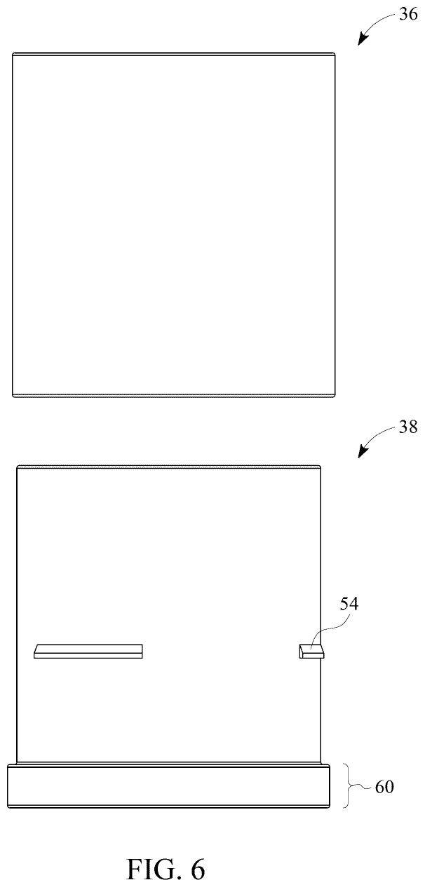

FIG. 6 provides an alternative view of the outer wall 36 and inner wall 38, emphasizing the configuration of the handle portion 60 and protrusion 54.

The device 10 provides an all-in-one solution for storing food, dispensing small portions, and collecting associated waste.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A device for storing and dispensing a food product and collecting waste associated with the food product, comprising:
a storage container configured to initially store the food product;
a door configured to selectively open and close the storage container to allow dispensing of the food product in small quantities into a user's hand;
a trash container configured to collect waste associated with the food product;
a lid configured to selectively open and close the trash container to receive the waste while preventing spillage of the food product disposed within the storage container when the door of the storage container is in a closed position.

2. The device of claim 1, wherein the door is rotatable between the open and closed positions.

3. The device of claim 1, wherein the storage container includes an inner wall and an outer wall, the inner wall being rotatable within the outer wall.

4. The device of claim 1, wherein the trash container is removably attached to the storage container for cleaning.

5. The device of claim 1, wherein the lid of the trash container is secured by a sealing mechanism to prevent odors from escaping.

6. The device of claim 1, wherein the storage container has a sloped bottom surface to facilitate dispensing of the food product when the door is in the opened position.

7. A method of using a device for storing and dispensing a food product and collecting waste, comprising:
holding the device in one hand;
twisting a handle portion of a storage container to open a door of the storage container;
tilting the device to dispense a portion of the food product into a user's hand;
closing the door to prevent further dispensing of the food product;
opening a lid of a trash container;
disposing of waste into the trash container;
closing the lid to secure the waste within the trash container.

8. The method of claim 7, wherein the waste is disposed of by putting the waste into the trash container through an opening of the trash container when the lid is in an open position.

9. The method of claim 7, wherein the storage container includes an inner wall and an outer wall, and the door is opened by rotating the inner wall relative to the outer wall.

10. The method of claim 7, wherein the trash container is emptied by unscrewing a top cover from a body of the device.

11. A method of assembling a device for storing and dispensing a food product and collecting waste, comprising:
securing an outer wall to a body of the device;
sliding an inner wall into the outer wall such that a protrusion on the inner wall engages a groove on the outer wall;
securing a top cover to a trash container body via a threaded engagement with a seal;
attaching a lid to the trash container to allow selective opening and closing for waste disposal.

12. The method of claim 11, wherein the inner wall is locked to the outer wall by using a unidirectional bevel configuration on the protrusion.

13. The method of claim 11, wherein the protrusion has a dual bevel configuration so that the trash container can be assembled for cleaning purposes.
